(19) United States
(12) Patent Application Publication
(10) Pub. No.: US 2008/0295612 A1
(43) Pub. Date: Dec. 4, 2008

(54) Torque Sensor

(76) Inventors: Dirk Rachui, Bietigheim-Bissingen (DE); Frank Jerems, Loechgau (DE); Jens Thom, Boeblingen (DE)

Correspondence Address: DREISS, FUHLENDORF, STEIMLE & BECKER, POSTFACH 10 37 62, D-70032 STUTTGART, DE

(21) Appl. No.: 11/667,407

(22) PCT Filed: Aug. 4, 2005
(86) PCT No.: PCT/EP05/08436

§ 371 Date: Mar. 20, 2008

(30) Foreign Application Priority Data
Nov. 10, 2004 (DE) 10 2004 055 124.3

(51) Int. Cl. G01L 3/00

(52) U.S. Cl. 73/862.333

(57) ABSTRACT

A torque sensor comprises a housing, a torsion device which is rotationally mounted inside the housing, a dynamic sensor unit which is rotationally fixed to the torsion device and a static sensor unit cooperating with the dynamic sensor unit. The static sensor unit is elastically connected to the housing via a decoupling device.

The invention concerns a torque sensor comprising a housing, a torsion device which is rotationally mounted inside the housing, a dynamic sensor unit which is rotationally fixed to the torsion device, and a static sensor unit cooperating with the dynamic sensor unit.

EP-A-1 269 133 discloses a torque sensor comprising a torsion device which is formed by a torsion rod. One end of the torsion rod comprises two ferromagnetic wheels with axially downwardly projecting teeth, and the other end comprises a ring magnet, which are rotated relative to each other when a torque acts on the torsion device. This torsion is detected by a magnet-sensitive element, e.g. a Hall sensor. The ferromagnetic wheels, the ring magnet, and the magnet sensor are constructed as one unit which, as a whole, is pushed onto the torsion device and connected thereto. It has turned out that in case of a defect, the whole unit must be exchanged even when only one electronic component fails. Moreover, the mounting tolerances have a disadvantageous effect on the measuring results, since the ferromagnetic wheels, the ring magnet and the sensor element are constructed as a rigid, inflexible unit.

DE-A-102 56 322 discloses a further torque sensor, wherein fixing of the Hall sensor is not defined. In the torque sensor of DE-A-198 28 513, the dynamic unit and the static unit are constructed as a torque unit in a housing. This torque unit can be handled only as a unit.

It is the underlying purpose of the invention to provide a torque sensor which requires little maintenance and is insensitive to mounting tolerances.

This object is achieved in accordance with the invention with a torque sensor of the above-mentioned type in that the static sensor unit is elastically connected to the housing via a decoupling device.

In the inventive torque sensor, the measured data is generated from the dynamic sensor unit and the static sensor unit, wherein the dynamic sensor unit is mounted to the torsion means and the static sensor unit is indirectly connected to the housing, i.e. not rigidly but elastically via a decoupling device. In consequence thereof, the static sensor unit can change its position, since it is quasi elastically suspended. This compensates for mounting tolerances. A further substantial advantage is that the static sensor unit can be exchanged independently of the dynamic sensor unit, since it is mounted to the housing. A torque sensor of this design requires less maintenance and is also less sensitive to mounting tolerances.

In a further development, the static sensor unit has a first sensor part which is mounted to the housing via the decoupling device, and a second sensor part which engages the torsion means. By dividing the static sensor unit into several, in particular, a first and a second sensor part, one sensor part can be directly connected to the dynamic sensor unit, such that this second sensor part can be handled together with the dynamic sensor unit. The first sensor part can be separately handled and is mounted to the housing. The first sensor part abuts the housing via the elastic coupling device and its position can therefore be corrected. Both static mounting tolerances and dynamic tolerances during operation of the sensor, i.e. axial and radial motion of the shaft relative to the housing, thereby have less effect on the static sensor unit, since it can follow the mounting tolerances. Distortions are prevented.

In accordance with a further development of the invention, the two sensor parts are detachably connected to each other. Only the first sensor part which is mounted to the housing must thereby be released to perform maintenance and/or replace parts.

In a further development, the static sensor unit is moreover detachably connected to the housing. For this reason, both, i.e. the first and the second sensor parts can be removed together from the housing and from the dynamic sensor unit. This also substantially facilitates maintenance and replacement of parts.

A detachable connection is realized e.g. by a screw connection, a locking connection or a clamping connection. Other detachable connections are also feasible.

In accordance with the invention, the detachable connection can be accessed from outside the housing in order to further facilitate maintenance, mounting and/or replacement work. This means that the torque sensor need not be disassembled into its individual parts, as in prior art, in case of an electronic defect to exchange components. Towards this end, the static sensor unit and, when the construction comprises several parts, only the first sensor part preferably comprises the electronic components of the torque sensor. The electronic components are therefore not distributed over all sensor units but combined in the static sensor unit and, in particular, in a first sensor part of this static sensor unit. Since exchange from outside of the housing is possible, the torque sensor need not be completely detached.

The static sensor unit can be optimally decoupled from the housing in that the decoupling device is elastic in a radial and/or axial direction. The decoupling device may thereby be designed e.g. as a membrane or membrane ring, whereby the membrane or membrane ring additionally seals the housing or housing interior.

The decoupling device in accordance with the invention is designed as a part of a lid that closes a housing opening. The inside of the housing can be accessed after removal of the lid, thereby also removing the static sensor unit or a first sensor part of the static sensor unit. This also substantially facilitates maintenance work.

The decoupling device is e.g. produced from plastic material, in particular, an elastomer, of spring steel, in particular a corrugated tube or a corresponding elastic material. Such materials or components are elastic, can transmit forces and correct position deviations.

Further advantages, features and details of the invention can be extracted from the dependent claims and the subsequent description which describes in detail a particularly preferred embodiment with reference to the drawing. The features shown in the drawing and described in the description and the claims may be essential to the invention either individually or collectively in arbitrary combination.

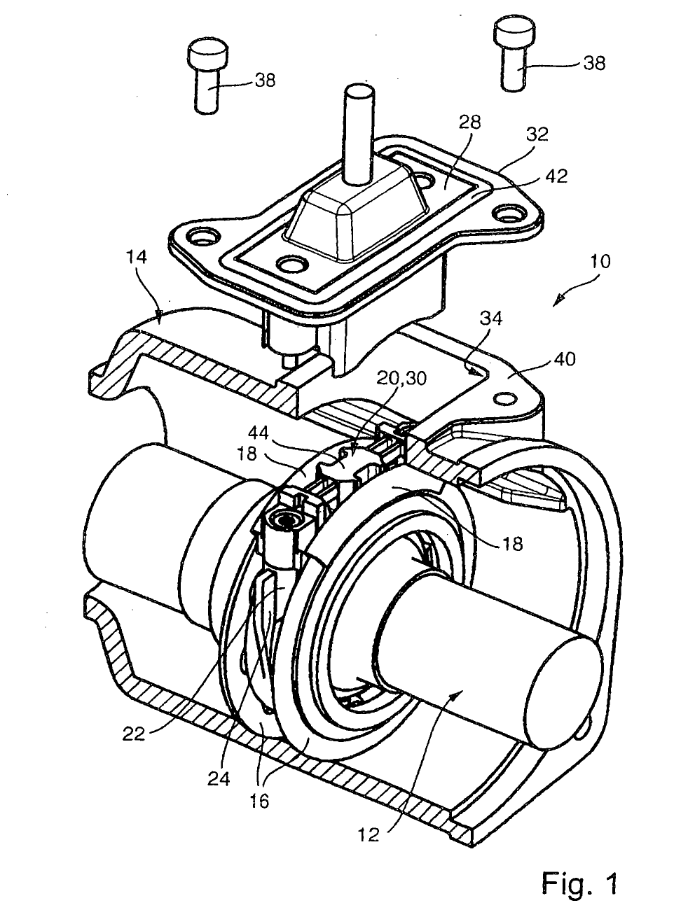

FIG. 1 shows an exploded view of a torque sensor with partially cut-open housing;

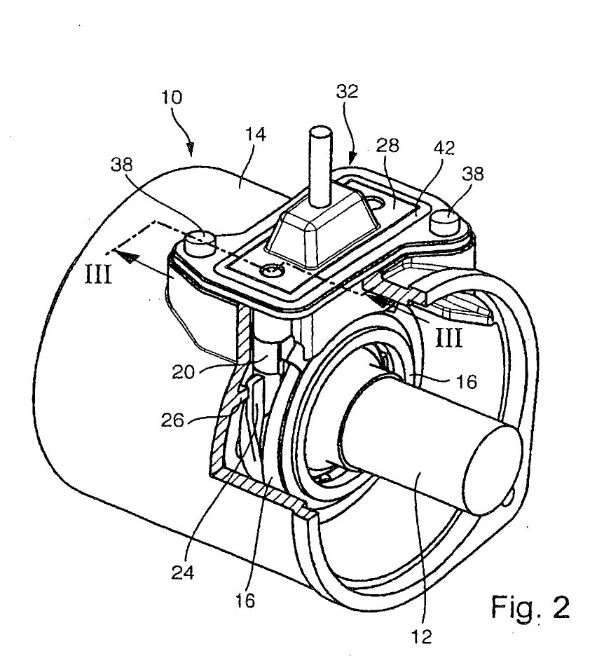

FIG. 2 shows a perspective view of the torque sensor with partially cut-open housing; and

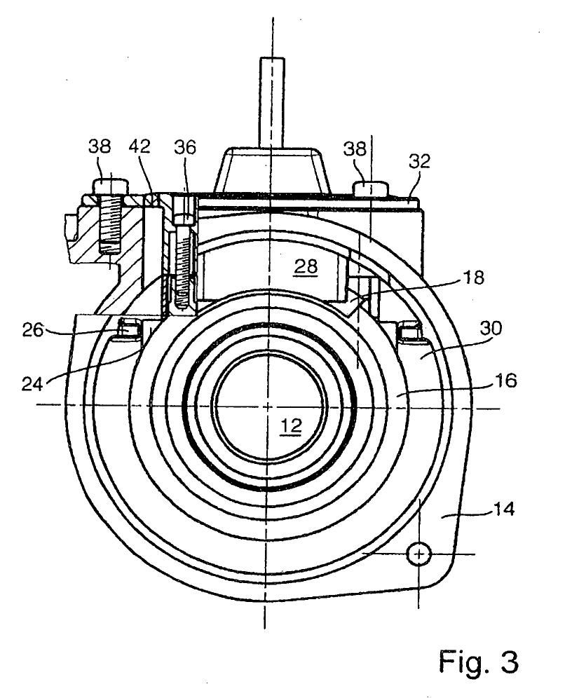

FIG. 3 shows a side view of the torque sensor with section III-III in accordance with FIG. 2.

Reference numeral 10 in FIG. 1 shows a torque sensor comprising a torsion device 12 which is rotationally disposed in a housing 14 via bearings, e.g. ball bearings or the like (not shown). Two circular ring-shaped, ferromagnetic torque sensor units are mounted to the torsion device 12, which are designated below as dynamic sensor unit 16. This dynamic sensor unit 16 is partially overlapped by two magnetic flux concentrators 18, wherein the magnetic flux concentrators 18 are part of a static sensor unit 20. This static sensor unit 20 has a sliding ring 22 which encompasses a sliding bearing (not shown) of the torsion device 12 and is supported on shoulders 26 (FIG. 2) provided on the inner side of the housing 14 via axially downwardly protruding wings 24, such that the static sensor unit 20 does not rotate together with the torsion device 12.

The static sensor unit 20 is formed by a first sensor part 28 and a second sensor part 30, wherein the second sensor part 30 surrounds the torsion device 12 and the first sensor part 28 is mounted to a lid 32 which closes a housing opening 34. The two sensor parts 28 and 30 can be rigidly connected via a screw connection 36 (FIG. 3), wherein the screw connection 36 can be accessed from outside of the housing 14. The lid 32 itself is screwed tightly to a flange 40 of the housing 14 using screws 38.

FIGS. 1 and 2 show that the first sensor part 28 is fixed in the lid 32 via a decoupling device 42, wherein the decoupling device 42 completely surrounds the first sensor part 28 and elastically or flexibly supports it.

When, after disposing the lid 32 onto the flange 40, the first sensor part 28 is connected to the second sensor part 30 via the screw connection 36, and the lid 32 is subsequently screwed to the housing 14 via the screws 38, remaining distortions or production or mounting tolerances between the static sensor unit 20 and the torsion device 12 are compensated for by the dynamic sensor unit 16 (static mounting tolerances) as well as dynamic tolerances during operation (concentricity inaccuracies and the like), since the decoupling device 42 decouples the first sensor part 28 from the lid 32 and thereby from the housing 14. This decoupling device 42 is e.g. a plastic membrane which has elastic properties both in axial and radial directions.

All electronic components are moreover housed in the first sensor part 28, such that only the lid 32 must be removed from the housing 14 and replaced by a new lid for maintenance and/or repair. Complete disassembly of the torque sensor 10 is not required.

The upper side 44 of the second sensor part 30 is designed such that the electronic components of the first sensor part 28, such as Hall sensors and the like, can be inserted from the top, i.e. orthogonally to the upper side 44, into the second sensor part 30.

Maintenance and/or repair work can be performed within a considerably shorter time and therefore at reduced cost using the inventive torque sensor 10. Furthermore, static mounting tolerances and dynamic tolerances have no influence on the sensor signal.

1-13. (canceled)

14. A torque sensor comprising:
a housing;
a torsion device which is rotationally disposed in said housing;
a dynamic sensor unit which is connected to said torsion device for secure mutual rotation therewith;
a static sensor unit which communicates with said dynamic sensor unit; and
a decoupling device disposed between and elastically connecting said static sensor unit and said housing.

15. The torque sensor of claim 14, wherein said static sensor unit has a first sensor part which is mounted to said housing via said decoupling device and a second sensor part which engages on said torsion device.

16. The torque sensor of claim 15, wherein said second sensor part is connected to a sliding bearing of said torsion device via a bearing element.

17. The torque sensor of claim 16, wherein said bearing element is a sliding ring.

18. The torque sensor of claim 15, wherein said first and said second sensor parts cooperate with each other via a detachable connection.

19. The torque sensor of claim 14, wherein said static sensor unit is detachably connected to said housing.

20. The torque sensor of claim 18, wherein said detachable connection is a screw connection, a locking connection, or a clamping connection.

21. The torque sensor of claim 18, wherein said detachable connection is accessible from outside said housing.

22. The torque sensor of claim 14, wherein said static sensor unit comprises electronic components of the torque sensor.

23. The torque sensor of claim 15, wherein said a first sensor part comprises electronic components of the torque sensor.

24. The torque sensor of claim 14, wherein said decoupling device is elastic in a radial and/or axial direction.

25. The torque sensor of claim 14, wherein said decoupling device is designed as a membrane or membrane ring.

26. The torque sensor of claim 15, wherein said decoupling device is part of a lid that closes an opening in said housing.

27. The torque sensor of claim 26, wherein said static sensor unit is part of said lid.

28. The torque sensor of claim 26, wherein said first sensor part is part of said lid.

28. The torque sensor of claim 14, wherein said decoupling device comprises plastic material, an elastomer, spring steel, or a corrugated tube.
